(19) United States
(12) Patent Application Publication
(10) Pub. No.: US 2026/0208811 A1
(43) Pub. Date: Jul. 23, 2026

(54) STEERING SYSTEM SERVICING DEVICE FOR CYCLES AND RELATED METHODS

(71) Applicant: Brian Kenton, Holladay, UT (US)

(72) Inventor: Brian Kenton, Holladay, UT (US)

(21) Appl. No.: 19/035,039

(22) Filed: Jan. 23, 2025

(51) Int. Cl. B62J 50/00

(52) U.S. Cl. CPC B62J 50/00

(57) ABSTRACT

A device for servicing a steering system of a cycle includes a main body configured to be mounted on a frame of the cycle and a fork platform configured to extend from the main body and support a fork of the cycle while the main body is mounted on the frame. A method servicing a steering system of a cycle may include mounting such a device to a frame of the cycle, removing a stem of the cycle from a steerer tube of a fork of the cycle, and resting the fork on the fork platform of the device.

### BACKGROUND

Servicing the steering system of two-wheeled and three-wheeled vehicles, such as bicycles, tricycles, motorcycles, electric assist bicycles, and electric motorcycles (referred to collectively hereinafter as “cycles”), presents several challenges related to disassembly, reassembly, and component management. These steering systems typically include handlebars, a stem, a headset, a fork, and a wheel. The steering system is mounted so as to extend through a head tube of a frame of the cycle. The headset allows the steering system to rotate about a rotational axis that extends through a center of the head tube. The headset includes bearings that allow a steerer tube of the fork to pivot within the head tube of the frame. The handlebar, which the rider uses to steer, is attached to the top end of the steerer tube of the fork via the stem. The fork optionally may include a suspension system.

Control components, such as components for breaking, shifting gears, etc., are also frequently mounted on the steering system. These components are often precisely positioned on the handlebars to accommodate rider preferences or optimize performance.

The various components of the steering system require periodic servicing. Furthermore, it is common for a rider to upgrade, change, or adjust components of the steering system. Due to the complexity of the steering system, it can be difficult for a single person to disassemble and reassemble the steering system.

Additionally, in some instances, it is desirable to disassemble and reassemble components of the steering system while control lines (brake lines, gear shifting lines, etc.) remain connected to the handlebars and/or the fork. In these instances, the fork and handlebars either need to be manually supported, secured to the frame or service stand using a cable or tie system, rested on a flat surface like the floor or a work table, or left to hang by the control lines, which are also attached to other components of the cycle. The latter option—allowing the fork and handlebars to hang from the control lines—is the most undesirable, as it places undue stress on the control lines, but it remains a common practice due to convenience.

### BRIEF SUMMARY

Embodiments of the disclosure include a device for servicing a steering system of a cycle. The device includes a main body configured to be mounted on a frame of a cycle. The device also includes a fork platform configured to extend from the main body and support a fork of the cycle while the main body is mounted on the frame of the cycle and during servicing of the steering system.

Another embodiment of the disclosure includes a method of servicing a steering system of a cycle. The method includes mounting a device to a frame of the cycle, where the device includes a main body configured to be mounted on a frame of a cycle, and a fork platform configured to extend from the main body and support a fork of the cycle while the main body is mounted on the frame of the cycle and during servicing of the steering system. The method also includes removing a stem of the cycle from a steerer tube of a fork of the cycle. The method also includes resting the fork on the fork platform of the device.

### BRIEF DESCRIPTION OF THE SEVERAL VIEWS OF THE DRAWINGS

While the specification concludes with claims particularly pointing out and distinctly claiming embodiments of the present disclosure, the advantages of embodiments of the disclosure may be more readily ascertained from the following description of embodiments of the disclosure when read in conjunction with the accompanying drawings in which:

FIG. 1A is a perspective view of a steering system servicing device according to an embodiment of the present disclosure;

FIG. 1B is a front view of the device;

FIG. 1C is a side view of the device;

FIG. 1D is a top view of the device;

FIG. 2A is a perspective view of a steering system servicing device according to an embodiment of the present disclosure;

FIG. 2B is a front view of the device of FIG. 2A;

FIG. 3 is a perspective view of a steering system servicing device according to an embodiment of the present disclosure;

FIG. 4A is a partial side view of a bicycle illustrating the device of FIGS. 1A-1D mounted on the bicycle in preparation for servicing the steering system of the bicycle;

FIG. 4B is a perspective view of the assembly shown in FIG. 4A;

FIG. 4C is a front view of the assembly shown in FIGS. 4A-4B;

FIG. 4D is a top view of the assembly shown in FIGS. 4A-4C;

FIGS. 5A and 5B are similar to FIGS. 4A and 4C, respectively, but illustrate the handlebar of the bicycle removed from the steerer tube of the fork and supported by the additional support member of the steering system servicing device, the fork supported by the fork platform of the steering system servicing device;

FIG. 6A is a front view of the assembly like that shown in FIGS. 4C and 5B, respectively, but illustrates the fork of the bicycle removed from the head tube of the frame of the bicycle and supported by the steering system servicing device on a lateral side thereof; and

FIG. 6B is a side view of the assembly shown in FIG. 6A.

### DETAILED DESCRIPTION

The following description provides specific details of an embodiment of a steering system servicing device in accordance with embodiments of the present disclosure, such as material compositions, shapes, and sizes, in order to provide a thorough description of example embodiments of the disclosure. However, a person of ordinary skill in the art would understand that the embodiments of the disclosure may be practiced without employing these specific details. Indeed, the embodiments of the disclosure may be practiced in conjunction with conventional techniques employed in the industry.

Drawings presented herein are for illustrative purposes only. Variations from the shapes depicted in the drawings as a result, for example, of manufacturing techniques and/or tolerances, are to be expected. Thus, embodiments described herein are not to be construed as being limited to the particular shapes or regions as illustrated, but include deviations in shapes that result, for example, from manufacturing. For example, a region illustrated or described as box-shaped may have rough and/or nonlinear features, and a region illustrated or described as round may include some rough and/or linear features. Moreover, sharp angles that are illustrated may be rounded, and vice versa. Thus, the regions illustrated in the figures are schematic in nature, and their shapes are not intended to illustrate the precise shape of a region and do not limit the scope of the present claims. The drawings are not necessarily to scale. Additionally, elements common between figures may retain the same numerical designation.

As used herein, the term “substantially” in reference to a given parameter means and includes to a degree that one skilled in the art would understand that the given parameter, property, or condition is met with a small degree of variance, such as within acceptable manufacturing tolerances. By way of example, depending on the particular parameter, property, or condition that is substantially met, the parameter, property, or condition may be at least 90.0 percent met, at least 95.0 percent met, at least 99.0 percent met, at least 99.9 percent met, or even 100.0 percent met.

As used herein, “about” in reference to a numerical value for a particular parameter is inclusive of the numerical value and a degree of variance from the numerical value that one of ordinary skill in the art would understand is within acceptable tolerances for the particular parameter. For example, “about” in reference to a numerical value may include additional numerical values within a range of from 90.0 percent to 110.0 percent of the numerical value, such as within a range of from 95.0 percent to 105.0 percent of the numerical value, within a range of from 97.5 percent to 102.5 percent of the numerical value, within a range of from 99.0 percent to 101.0 percent of the numerical value, within a range of from 99.5 percent to 100.5 percent of the numerical value, or within a range of from 99.9 percent to 100.1 percent of the numerical value.

As used herein, relational terms, such as “below,” “lower,” “bottom,” “above,” “upper,” “top,” and the like, may be used for ease of description to describe one element's or feature's relationship to another element(s) or feature(s) as illustrated in the drawings. Unless otherwise specified, the spatially relative terms are intended to encompass different orientations of the elements in addition to the orientation depicted in the figures. For example, if elements in the figures are inverted, elements described as “below” or “under” or “on bottom of” other elements or features would then be oriented “above” or “on top of” the other elements or features. Thus, the term “below” can encompass both an orientation of above and below, depending on the context in which the term is used, which will be evident to one of ordinary skill in the art. The elements may be otherwise oriented (e.g., rotated 90 degrees, inverted, flipped) and the spatially relative descriptors used herein interpreted accordingly.

As used herein, the terms “vertical” and “lateral” are in reference to a major plane of a structure and are not necessarily defined by earth's gravitational field. A “horizontal” or “lateral” direction is a direction that is substantially parallel to the major plane of the structure, while a “vertical” or “longitudinal” direction is a direction that is substantially perpendicular to the major plane of the structure. The major plane of the structure is defined by a surface of the structure having a relatively large area compared to other surfaces of the structure.

As used herein, the term “servicing the steering system” may include any work done to the steering system, including but not limited to changing components, cleaning, routine maintenance, adjusting alignment of components, etc.

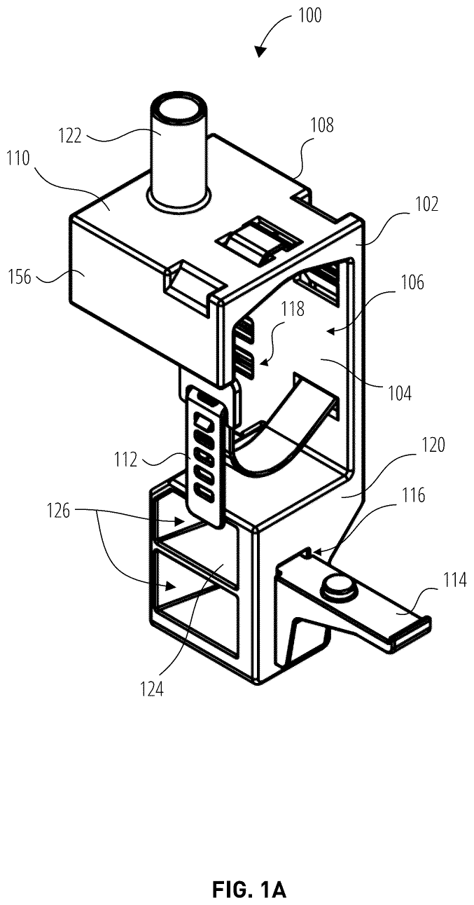

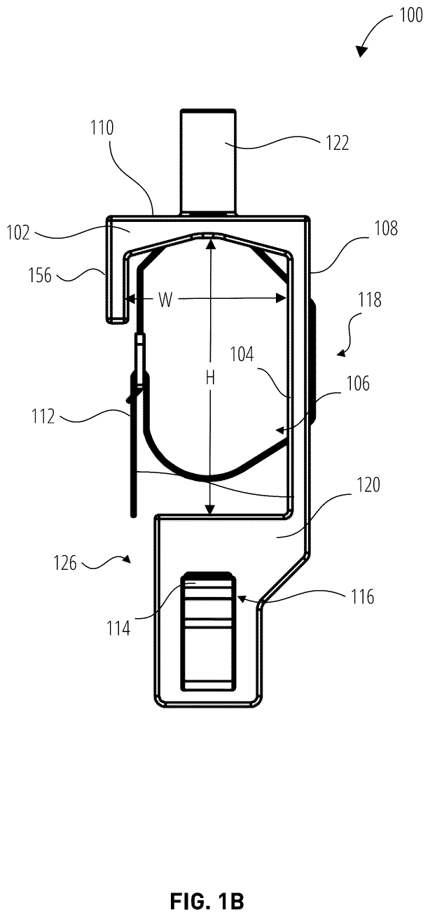

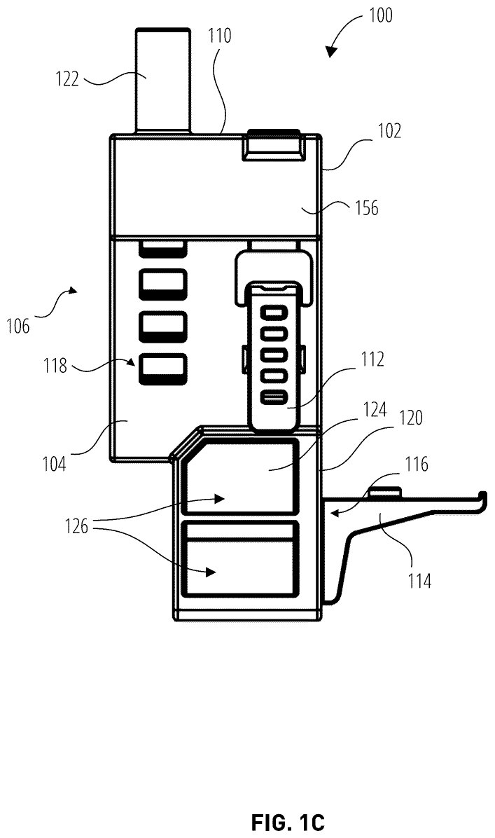

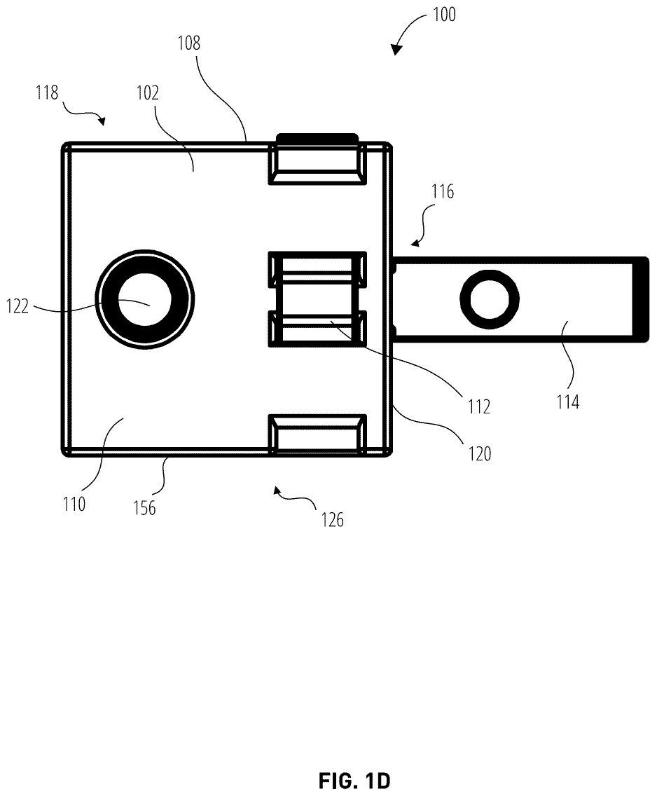

FIGS. 1A-1D illustrate a steering system servicing device 100 as seen from various perspectives according to embodiments of the disclosure. The device 100 may include a main body 102 having a surface 104 defining a channel 106, a first lateral surface 108, a second lateral surface 156, an upper surface 110, and a front surface 120. The main body 102 also includes an internal surface 124 defining one or more compartments 126 within the main body 102. The device also includes a fork platform 114 for supporting a fork of a cycle. In some embodiments, the fork platform 114 may be attached to the main body 102 at either a first attachment location 116 or a second attachment location 118. The device 100 may also include a fastening element 112 for securely fastening the device 100 to the frame of a cycle, and may also include an additional support member 122 for supporting a handlebar of a cycle. The device 100 is described in further detail below.

The main body 102 of the device 100 may be configured to be mounted on a frame of a cycle. For example, the main body 102 may be configured to be mounted on a top tube of the cycle, on a down tube of the cycle, or elsewhere on the cycle (e.g., on a head tube of the cycle). In some embodiments, the main body 102 may be a unitary body (i.e., formed from a single piece). In these embodiments, the main body 102 may have an opening configured to allow the main body 102 to be mounted on the frame. In other embodiments, the main body 102 may be formed of two or more pieces configured to allow the main body 102 to be mounted on the frame of the cycle. For example, the two or more pieces of the main body 102 may be hingedly connected, or slotted together, so as to allow the main body 102 to be opened and mounted on the frame of the cycle. Configuring the main body 102 as a unitary body may provide certain benefits, such as enhanced structural integrity, material efficiency, and reduced assembly complexity. In contrast, configuring the main body 102 as two or more interconnected pieces may allow for enhanced flexibility in manufacturing and repair, and may enable additional options for mounting the main body 102 on the frame of the cycle.

The main body 102 may include a surface 104 defining a channel 106. The main body 102 may further include a first lateral surface 108, a second lateral surface 156 opposite the first lateral surface 108, and an upper surface 110. The surface 104 may face towards the frame of the cycle when the main body 102 is mounted on the frame. The surface 104 may be opposite the first lateral surface 108, the second lateral surface 156, and the upper surface 110, separated from the first lateral surface 108, the second lateral surface 156, and the upper surface 110 by a thickness of the main body 102, a material of the main body 102 interposed between the surface 104 and the first lateral surface 108, between the surface 104 and the second lateral surface 156, and between the surface 104 and upper surface 110. The upper surface 110, the first lateral surface 108, and the second lateral surface 156 may face away from the frame of the cycle when the main body 102 is mounted on the frame.

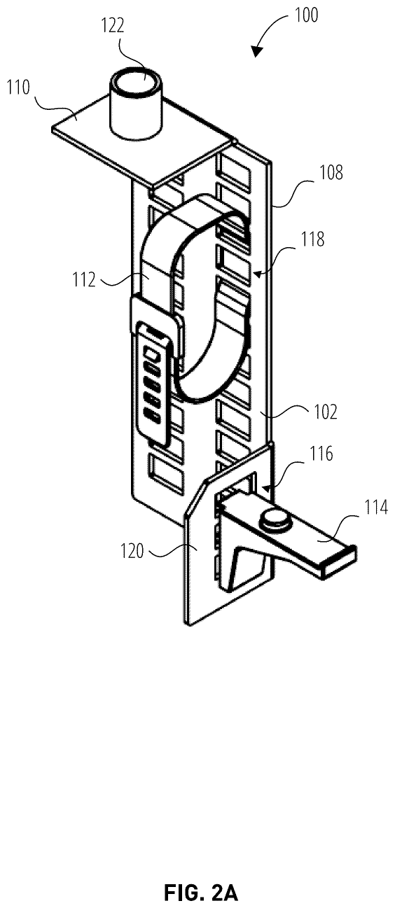

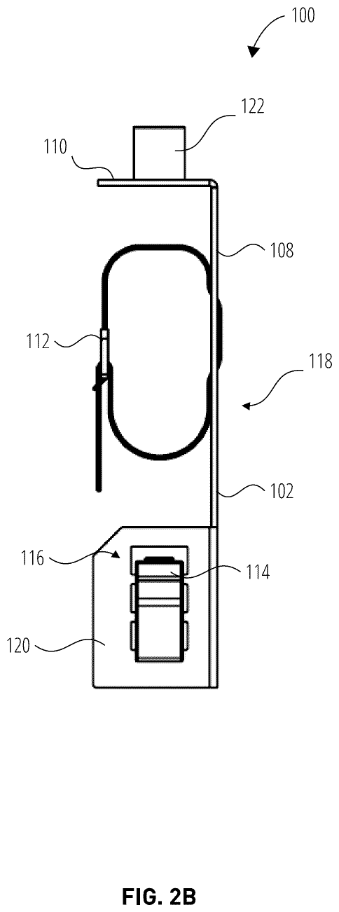

The channel 106 may extend in and along the main body 102, and may be sized and configured to receive a tube of the frame of the cycle therein when the main body 102 is mounted on the frame. For example, in some embodiments the channel 106 may have a rectangular shape or a circular shape, and may have, respectively, a height and a width, or a diameter, that is substantially the same size as, or larger than, a height and a width, or a diameter, of the top tube, the down tube, or the head tube of the frame of the cycle. For example, as illustrated in FIG. 1B, the main channel 106 may have a height (H) of between about 2 centimeters and about 8 centimeters, and a width (W) of between about 2 centimeters and about 8 centimeters. However, the channel 106 is not limited to a rectangular or circular shape, and may be configured in any shape or dimension configured to receive a tube or other structural member of a frame of a cycle. The channel 106 may facilitate mounting the main body 102 on the frame. As discussed in further detail below with relation to FIG. 2A and FIG. 2B, in some embodiments, the main body 102 may not include the channel 106.

The device 100 may include a fastening element 112. The fastening element 112 may be configured to fasten the main body 102 to the frame of the cycle, such as to the top tube, the down tube, or the head tube of the cycle. The fastening element 112 may be, for example, a strap, a tie, a clamp, or any other suitable fastening element configured to fasten the main body 102 to the frame of the cycle. In the illustrated embodiments, the fastening element 112 includes a strap, and the strap may be threaded, for example, through the first lateral surface 108 and/or the upper surface 110 of the main body 102 and substantially encircle the channel 106. The fastening element 112 may allow the main body 102 to be secured to the frame of the cycle so as to prevent dislocation of the main body 102 during servicing of the steering system.

The device 100 includes a fork platform 114 for supporting the fork of a cycle during servicing of the steering system. The fork platform 114 may extend away from the main body 102. In some embodiments the fork platform 114 and the main body 102 may be two portions of one integral body. In these embodiments, the fork platform 114 may be configured to move (e.g., pivot) to allow the steerer tube of the fork to be removed from the head tube of the cycle. For example, the fork platform 114 may be permanently attached to the main body by a kinematic system (e.g., one or more hinges and one or more stopping mechanisms) that allows the fork platform 114 to pivot downward (e.g., toward the ground) to provide clearance so that the steerer tube of the fork can be removed from the head tube of the cycle. In additional embodiments where the fork platform 114 and the main body 102 are two portions of one integral body, the fork platform 114 may be located on the first lateral surface 108 of the main body 102. In further embodiments the main body 102 may include two permanently attached fork platforms 114, one located on the first lateral surface 108, and one located on the front surface 120 and configured to move (e.g., pivot) downward.

In other embodiments the fork platform 114 and the main body 102 may be separable elements, and the fork platform 114 may be attachable to and detachable from the main body 102. The fork platform 114 may be configured in various shapes and sizes to support forks of varying shapes and sizes. For example, a fork platform 114 configured to support a fork of a mountain bike or a motorcycle may be larger than a fork platform 114 configured to support a fork of a road bike.

Configuring the fork platform 114 to be attachable to and detachable from the main body 102 may allow for customization and replacement of parts. For example, fork platforms 114 of different shapes and sizes may be swapped in and out to service different kinds of cycles, and if one fork platform 114 breaks, it may be replaced easily. On the other hand, configuring the fork platform 114 and main body 102 as one integral body may simplify and streamline fabrication of the device 100. This approach may also enhance structural integrity of the device 100 by minimizing potential points of failure at attachment interfaces.

In embodiments where the fork platform 114 and main body 102 are separable elements, the main body 102 may be configured such that the fork platform 114 is attachable to and detachable from at least two different attachment locations on the main body 102. For example, the main body 102 may include at least a first attachment location 116 and a second attachment location 118, and the fork platform 114 may be attached to the main body 102 at the first attachment location 116 or at the second attachment location 118. The first attachment location 116 may be located on a front surface 120 of the main body 102, the front surface 120 facing a head tube of a frame of a cycle when the main body 102 is mounted on the frame of the cycle. The second attachment location 118 may be located on the first lateral surface 108 of the main body 102 when the main body 102 is mounted on the frame of the cycle, the first lateral surface 108 being substantially perpendicular to the front surface 120 of the main body 102 and facing away from the tube of the frame when the main body 102 is mounted on the tube.

In other embodiments, the main body includes at least two different attachment locations on the front surface 120. For example, the second attachment location 118 may be located on the front surface 120 of the main body 102, adjacent to (e.g., vertically above or below) the first attachment location 116. The at least two different attachment locations on the front surface 120 of the main body 102 may facilitate the servicing of cycles of various shapes and sizes. The height of the bottom of the fork relative to the top of the down tube of the frame may change depending on the type of cycle being serviced (e.g., a length of the head tube may vary, a geometry of the cycle may vary, etc.). The multiple attachment locations on the front surface 120 of the main body 102 may allow a service operator to adjust a position of the fork platform to accommodate the differing positions of the fork. In some embodiments, the main body 102 includes a plurality of attachment locations, such as three or more attachment locations on the front surface 120 of the main body 102 and three or more attachment locations on the first lateral surface 108 of the main body 102. In embodiments where the fork platform 114 and main body 102 are two portions of one integral body and the fork platform 114 is not detachable from the main body 102, the fork platform 114 may be located on the first lateral surface 108 of the main body 102, or the fork platform 114 may be located on the front surface 120 of the main body 102, and the fork platform 114 may be configured to move (e.g., pivot) downward so as to allow the steerer tube of the fork to be removed from the head tube of the cycle, as discussed above. In further embodiments the main body 102 may include two permanently attached fork platforms 114, one located on the first lateral surface 108, and one located on the front surface 120 and configured to move (e.g., pivot) downward.

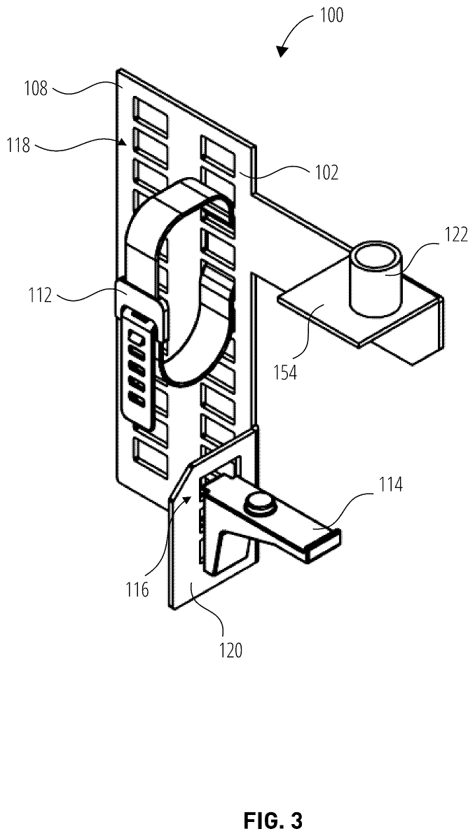

In some embodiments, the device 100 may further include an additional support member 122. The additional support member 122 may be configured to support a stem and/or handlebar of the cycle during servicing of the steering system. For example, in some embodiments the additional support member 122 may be configured to penetrate a steerer tube mount hole of the stem, thus supporting the stem and handlebar during servicing of the steering system. In other embodiments, the additional support member 122 may be configured to support (e.g., cradle) the handlebars. In some embodiments the additional support member 122 may be located, for example, on the upper surface 110 of the main body 102 and may extend away from the main body 102. In some embodiments the additional support member 122 may be integral with the main body 102, while in other embodiments the additional support member 122 may be attachable to and detachable from the main body 102. In some embodiments the additional support member 122 may have a cylindrical, square, rectangular, or other cross-sectional shape, and may be solid or tubular (i.e., hollow in the middle). In embodiments where the additional support member 122 is configured to cradle the handlebars, the additional support member 122 may include two notched support members (e.g., V-notches, arcs, etc.) configured to receive and support the handlebars. However, the additional support member 122 is not limited to such embodiments, and may be configured in any shape or size configured to support the stem and/or handlebar of the cycle. The additional support member 122 may facilitate supporting the stem and/or handlebar of the cycle during servicing of the steering system without disconnecting control lines (e.g., brake lines, gear shifting lines, etc.) from the steering system (although in some embodiments where, for example, control lines run through the headset, some control lines may need to be disconnected). As discussed below in relation to FIG. 3, in some embodiments the additional support member may be mounted to a support surface extending in a direction away from the front surface 120 of the main body 102.

The main body 102 may include one or more internal surfaces 124 defining one or more compartments 126 located within the main body 102. The one or more compartments 126 may be configured to store one or more components removed from the cycle during servicing of the steering system, or may store other components or tools employed in servicing the cycle 128. In some embodiments the one or more compartments 126 may be located vertically below the channel 106, as in the illustrated embodiment. The main body 102 may include, for example, one, two, three, or more compartments 126. In some embodiments the one or more compartments 126 are integral with the main body 102, while in other embodiments the one or more compartments 126 may be attachable to and detachable from the main body 102. The one or more compartments 126 may allow for quick and easy storage of components of the cycle and/or tools used during servicing of the steering system.

In some embodiments, the device 100 may further include additional elements configured to store tools employed during servicing of the steering system. For example, in some embodiments the main body 102 may include tool retention elements (e.g., slots, holes, compartments, holders, etc.), either integrated into or attachable to the main body 102, configured to securely hold maintenance tools (e.g., wrenches, screwdrivers, etc.), facilitating quick access during servicing operations. In other embodiments, the device 100 may not include additional tool retention elements.

The elements of the device 100, including, but not limited to, the main body 102, the channel 106, the fastening element 112, the fork platform 114, the additional support member 122, and the one or more compartments 126, may be configured in various shapes and sizes to accommodate cycles of various shapes and sizes. For example, the main body 102 of the device 100 may be designed in a range of sizes to fit different cycle frame geometries, ensuring compatibility with a broad spectrum of cycle models, including motorcycles and road bikes. The fork platform 114 may also be adapted to support forks of varying widths and lengths, accommodating, for example, both larger mountain bike forks and narrower road bike forks. Overall, these variations may allow the device to be tailored to meet the unique specifications of different cycles.

As discussed above and depicted in FIGS. 2A and 2B, in some embodiments, the main body 102 of the device 100 may not include a channel 106. For example, the main body 102 may not include the second lateral surface 156 and the surface 104 opposite the second lateral surface 156 defining the channel 106. In these embodiments, the main body 102 may be secured to the frame with the fastening element 112 alone. Configuring the main body 102 without the channel 106 may facilitate mounting the main body 102 at different heights on the frame of the cycle. For example, in embodiments where the fastening element 112 is a strap, the fastening element 112 may be threaded, for example, through the first lateral surface 108 at different heights, allowing the vertical position of the main body 102 to be adjusted relative to the frame of the cycle.

Additionally, as discussed above and depicted in FIG. 3, in some embodiments the additional support member 122 may be mounted to a support surface 154 extending away from the main body 102. The additional support member 122 on the support surface 154 may allow the stem and/or handlebar of the cycle to be supported in front of the head tube of the cycle.

The elements of the device 100, including the main body 102, fork platform 114, additional support member 122, and fastening element 112, may be formed of any suitable material, including, but not limited to, a polymer, metal, or composite material, or combinations thereof.

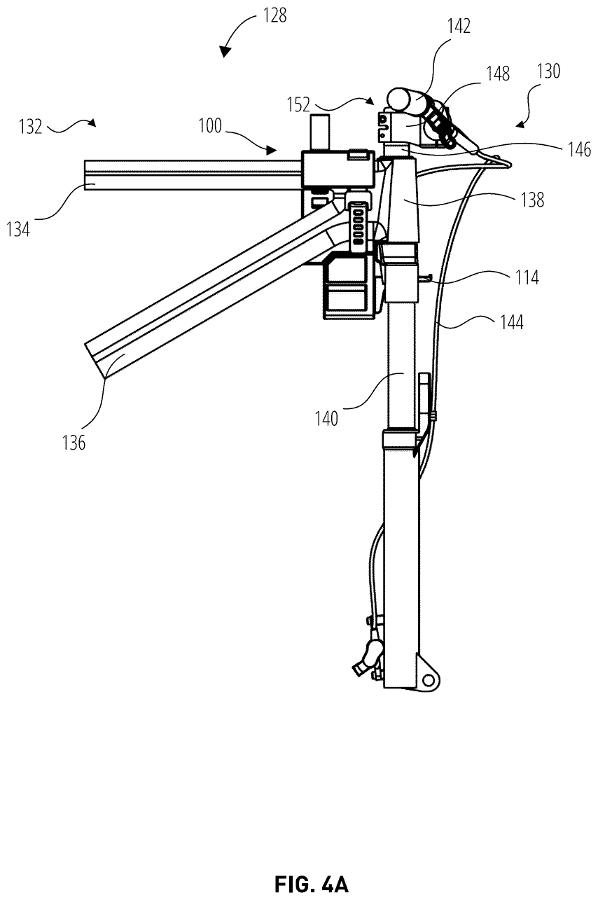

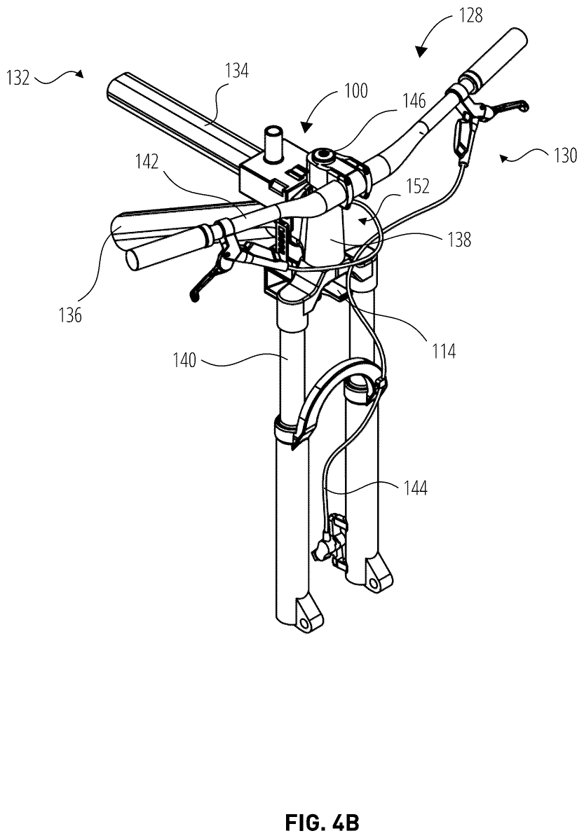

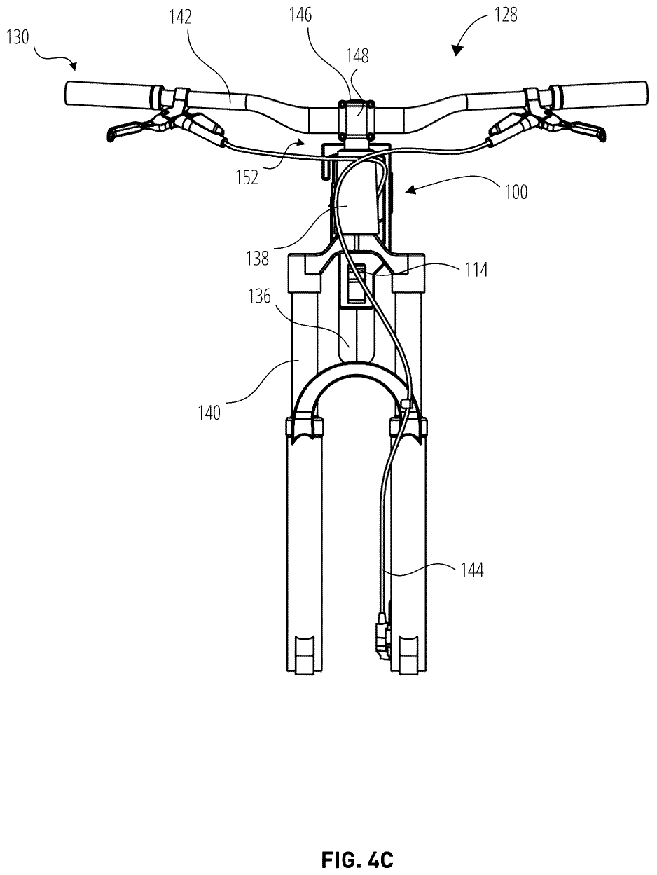

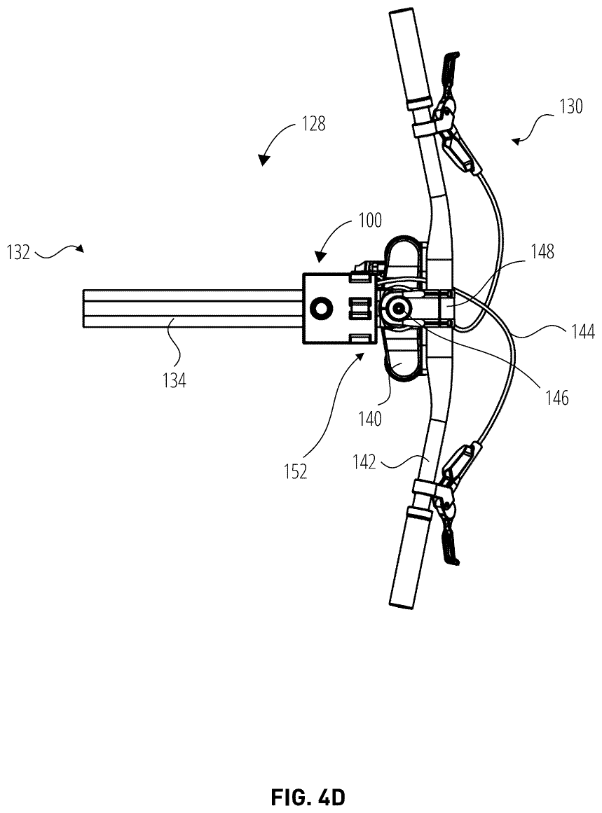

FIGS. 4A-4D illustrate the device 100 of FIGS. 1A-1D mounted on a cycle 128 during a stage of servicing a steering system 130 of the cycle 128 as seen from various perspectives in accordance with embodiments of the disclosure. The cycle 128 includes the steering system 130, a frame 132, and a fork 140. The frame 132 may include a top tube 134, a down tube 136, and a head tube 138. The steering system 130 may include a handlebar 142, control lines 144, a headset 146, a stem 148, and the fork 140. The fork includes a steerer tube 150. The steerer tube 150 of the fork 140 extends through the head tube 138, and the handlebar 142 is attached to a top end of the steerer tube 150 via the stem 148. The headset 146 includes components 152 (e.g., bearings) that allow the steerer tube 150 to pivot within the head tube 138.

When servicing the steering system 130 of the cycle 128 using the device 100, the cycle may be held off the ground using a conventional bike stand (not illustrated), and the main body 102 of the device 100 may be mounted on the frame 132 of the cycle 128. For example, in some embodiments, the main body 102 of the device 100 may be mounted on the top tube 134 of the frame 132. In other embodiments, the main body 102 may be mounted on the down tube 136 of the frame 132. The main body 102 may also be mounted, for example, on the head tube 138 of the frame 132. In some embodiments, the main body 102 may be mounted on one or more of the top tube 134, the down tube 136, and the head tube 138. When the main body 102 is mounted on the frame 132 the top tube 134, the down tube 136, and/or the head tube 138 may be disposed at least partially within the channel 106 of the device 100. In embodiments where the main body 102 does not include a channel 106, the top tube 134, down tube 136, and/or head tube 138 may be disposed at least partially within (e.g., substantially encircled by) the fastening element 112. By configuring the device 100 to be mounted on the frame 132 of the cycle 128, the device 100 according to embodiments of the disclosure renders additional support structures or elements (e.g., tables, stands, ties, etc.) unnecessary, thus streamlining the process of servicing the steering system 130.

In some embodiments the main body 102 may be mounted on the frame 132 by fastening the main body 102 to the frame 132 with the fastening element 112. For example, the main body 102 may be strapped or tied to the top tube 134, the down tube 136, and/or the head tube 138. Alternatively, in embodiments where the main body 102 is formed of two or more interconnected pieces, the pieces may be configured such that, when interconnected, they clamp the main body 102 to the top tube 134, the down tube 136, and/or the head tube 138 of the frame 132. In some embodiments the fastening element 112 includes a strap. As discussed above, the strap may be threaded through the first lateral surface 108 and/or the upper surface 110 of the main body 102, and may substantially encircle the top tube 134, down tube 136, and/or head tube 138 extending through the channel 106. The strap may be tightened to fasten the main body 102 to the frame 132 and prevent dislocation of the main body 102 during servicing of the steering system 130.

As discussed above, in some embodiments the fork platform 114 and the main body 102 may be two portions of one integral body, and in other embodiments the fork platform 114 and the main body 102 may be separable elements, and the fork platform 114 may be attachable to and detachable from the main body 102. In embodiments where the fork platform 114 and main body 102 are separable elements, when the main body 102 is mounted on the frame 132, the fork platform 114 may initially be attached to the main body 102 at the first attachment location 116 on the front surface 120 of the main body 102, the front surface 120 facing the head tube 138 when the main body 102 is mounted on the frame 132. In some embodiments where the fork platform 114 is integral with the main body 102, the fork platform 114 may be located on the first lateral surface 108 of the main body 102, the first lateral surface 108 being substantially perpendicular to the front surface 120 of the main body 102 and facing away from the top tube 134, the down tube 136, or the head tube 138 of the frame 132 when the main body 102 is mounted on the frame 132. In other embodiments where the fork platform 114 is integral with the main body 102 and is configured to move (e.g., pivot) with respect to the main body 102, the fork platform 114 may be located on the front surface 120 of the main body 102.

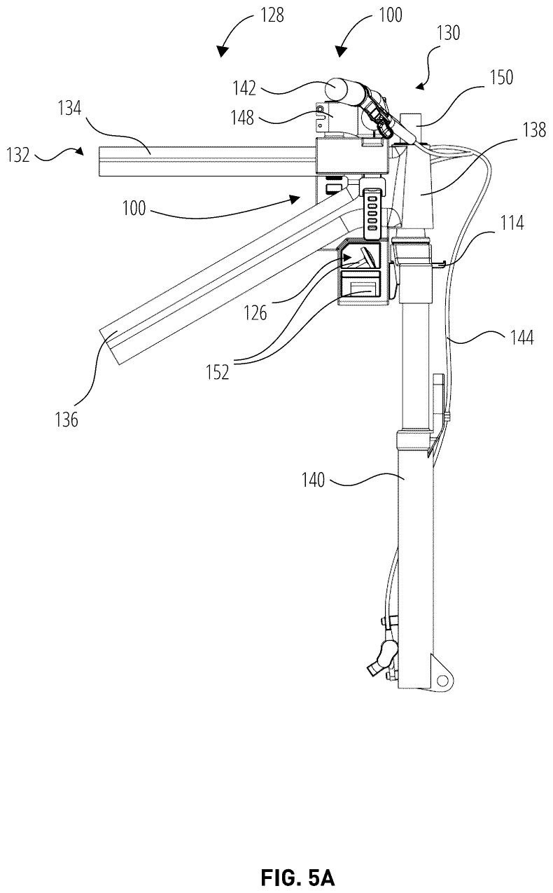

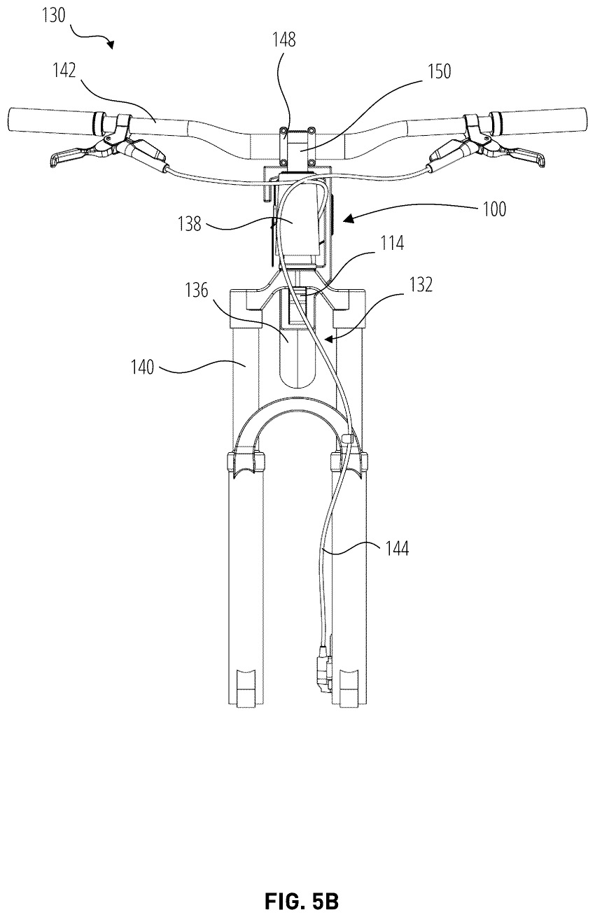

FIGS. 5A and 5B illustrate the device 100 of FIGS. 1A-1D mounted on the cycle 128 during a stage of servicing the steering system 130 of the cycle 128 as seen from various perspectives in accordance with embodiments of the disclosure.

With the main body 102 mounted on the frame 132 and the fork 140 supported by the fork platform 114, the stem 148 and/or the handlebar 142 of the steering system 130 may be detached from the steerer tube 150 and supported by the additional support member 122 of the device 100. In some embodiments one or more components 152 of the headset 146 may be detached from the steerer tube 150 and stored in the one or more compartments 126 within the main body 102.

As discussed above, in some embodiments the main body 102 may include an additional support member 122. In some embodiments the additional support member 122 is located on the upper surface 110 of the main body 102. The additional support member 122 may be configured to support the stem 148 and/or handlebar 142 during servicing of the steering system 130. For example, the additional support member 122 may be configured to penetrate a steerer tube mount hole of the stem 148 (i.e., a hole in the stem 148 through which the steerer tube 150 extends when the stem 148 is mounted on the steerer tube 150). The additional support member 122 may allow the stem 148 and/or handlebar 142 to be detached from the steerer tube 150 and stored on the main body 102 without disconnecting, in most cases, any of the control lines 144 (e.g., brake lines, gear shifting lines, etc.) from the handlebar 142 or using any additional support structures or ties to support the stem 148 and/or handlebar 142. In embodiments where the additional support member 122 is mounted on the support surface 154 extending away from the main body 102, the stem and/or handlebar may be stored in front of the head tube 138 on the additional support member 122.

In some embodiments the main body 102 may not include an additional support member 122. In these embodiments, the stem 148 and/or handlebar 142 may be detached from the steerer tube 150 and placed elsewhere, such as on a separate support structure (e.g., a stand, table, etc.) configured to support the stem 148 and/or handlebar 142 without disconnecting any control lines 144 from the handlebar 142. In some embodiments the stem 148 and/or handlebar 142 may be rested on the upper surface 110 of the main body 102.

With the stem 148 and/or handlebar 142 detached from the steerer tube 150 of the fork 140, the fork 140 of the cycle 128 may be supported by the fork platform 114 while the fork platform 114 is attached to the main body 102 at the first attachment location 116 and the steerer tube 150 extends through the head tube 138. In embodiments where the fork platform 114 and main body 102 are two portions of one integral body and the fork platform 114 is located on the first lateral surface 108 of the main body 102, once the stem 148 and handlebar 142 have been detached from the steerer tube 150 of the fork 140 and the steerer tube 150 still extends through the head tube 138, the fork 140 may be supported by other means (e.g., by a floor surface, manually by a service operator, by friction between the steerer tube 150 and head tube 138, etc.), or the fork 140 may be detached from the head tube 138 and placed on the fork platform 114 located on the first lateral surface 108 of the main body 102, as discussed in more detail below.

In some embodiments, one or more components 152 may be removed from the cycle 128 and stored in the one or more compartments 126. For example, a bolt, bearing, or other component 152 of the headset 146 may be removed from the stem 148 and/or the steerer tube 150 and stored in the one or more compartments 126. The compartments 126 are not limited to storing components of the headset 146, and may be used to store any object or tool used in servicing the cycle 128. Storing the one or more components 152 in the one or more compartments 126 may facilitate servicing the steering system 130 without losing or misplacing any of the one or more components 152, and may negate the need for any additional storage trays or structures.

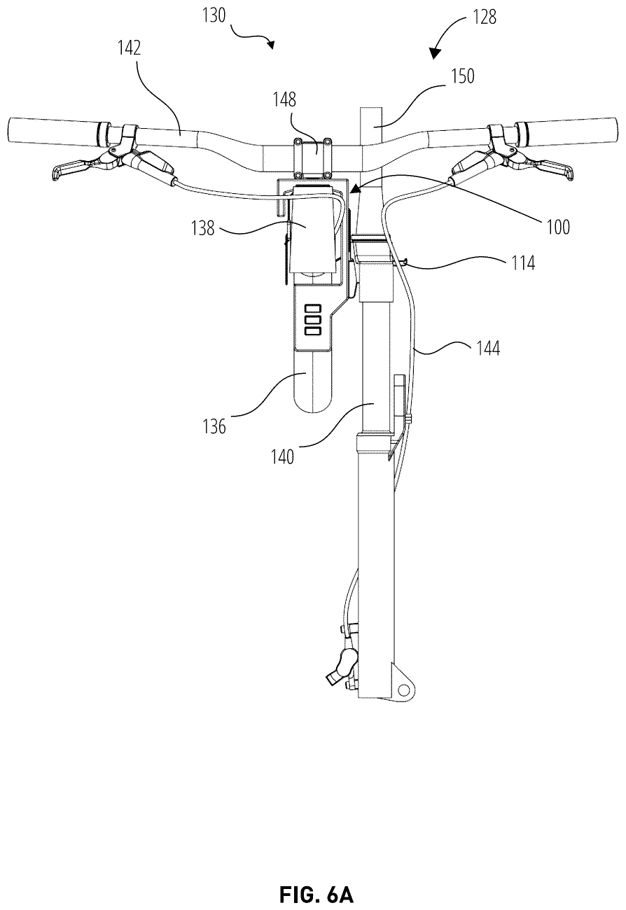

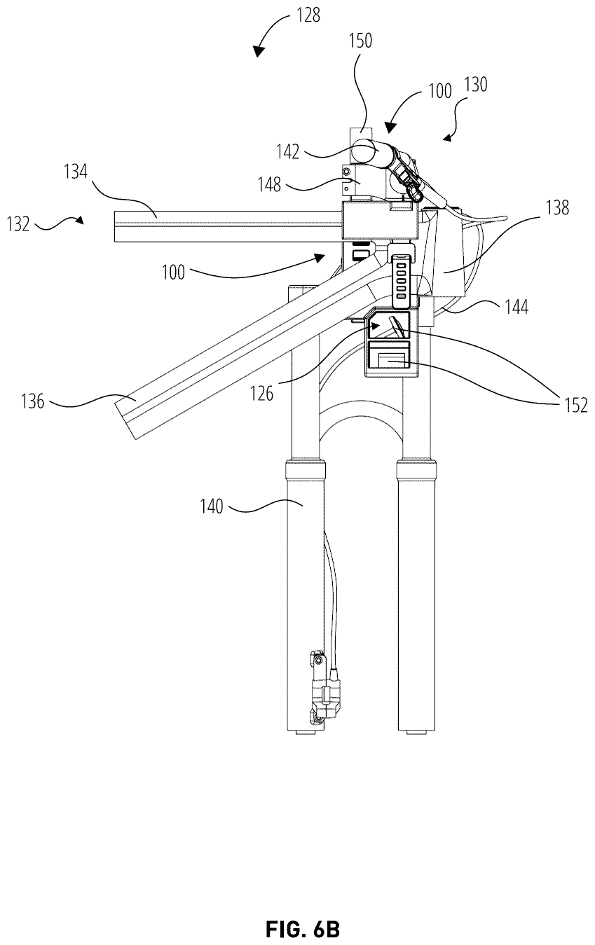

FIGS. 6A and 6B illustrate the device 100 of FIGS. 1A-1D mounted on the cycle 128 during a stage of servicing the steering system 130 of the cycle 128 as seen from various perspectives in accordance with embodiments of the disclosure.

With the stem 148 and handlebar 142 detached from the steerer tube 150, the fork 140 may be detached from the cycle 128 and placed on the fork platform 114. In some embodiments, the fork platform 114 may be detached from the first attachment location 116 on the front surface 120 of the main body 102 and attached to the second attachment location 118 on the first lateral surface 108 of the main body 102. The steerer tube 150 of the fork 140 may be removed from the head tube 138 so that the steerer tube 150 does not extend through the head tube 138, and the fork 140 may be placed on the fork platform 114 while the fork platform 114 is attached to the second attachment location 118. In embodiments where the fork platform 114 is integral with the main body 102 and the fork platform 114 is located on the first lateral surface 108 of the main body 102, the steerer tube 150 of the fork 140 may be removed from the head tube 138 so that the steerer tube 150 does not extend through the head tube 138, and the fork 140 may be placed on the fork platform 114. The fork platform 114 may provide a convenient and secure location to store the fork 140 during servicing of the steering system 130 without the need to remove control lines (e.g., the front brake line) from the fork 140.

With the fork 140 resting on the fork platform 114, and, in some embodiments, the stem 148 and/or the handlebar 142 resting on the additional support member 122, the steering system 130 may be serviced. For example, components 152 (e.g., bearings, etc.) of the headset 146, the fork 140, the stem 148, and/or handlebar 142 may be replaced, cleaned, or inspected for signs of wear or damage. Embodiments of the disclosure facilitate servicing of the steering system 130 of the cycle 128 without disconnecting, in most cases, any control lines 144 (e.g., brake lines, gear shifting lines, etc.) from the steering system 130, without allowing the stem 148 and handlebar 142 to hang by the control lines 144, and without the need for additional support structures or elements (e.g., tables, stands, ties, etc.). Thus, the device 100 may reduce the time and equipment needed to service the steering system 130 compared to conventional methods and devices, while also preventing damaging of the control lines 144.

The embodiments of the disclosure described above and illustrated in the accompanying drawing figures do not limit the scope of the invention, since these embodiments are merely examples of embodiments of the invention, which is defined by the appended claims and their legal equivalents. Any equivalent embodiments are intended to be within the scope of this disclosure. Indeed, various modifications of the disclosure, in addition to those shown and described herein, such as alternative useful combinations of the elements described, may become apparent to those skilled in the art from the description. Such modifications and embodiments are also intended to fall within the scope of the appended claims and their legal equivalents.

What is claimed is:

1. A device for servicing a steering system of a cycle, the device comprising:
a main body configured to be mounted on a frame of a cycle; and
a fork platform configured to extend from the main body and support a fork of the cycle while the main body is mounted on the frame of the cycle and during servicing of the steering system.

2. The device of claim 1, wherein the main body is a unitary body.

3. The device of claim 1, wherein the main body has a surface defining a channel extending in and along the main body, the channel sized and configured to receive a tube of the frame of the cycle therein when the main body is mounted on the frame of the cycle.

4. The device of claim 1, further comprising a fastening element for fastening the main body to the frame of the cycle.

5. The device of claim 4, wherein the fastening element comprises a strap.

6. The device of claim 1, wherein the main body has at least one internal surface defining at least one compartment within the main body.

7. The device of claim 1, wherein the fork platform and the main body are two portions of one integral body.

8. The device of claim 1, wherein the fork platform and the main body are separable elements, the fork platform being attachable to and detachable from the main body.

9. The device of claim 8, wherein the main body is configured such that the fork platform is attachable to at least two different attachment locations on the main body.

10. The device of claim 9, wherein at least one attachment location of the at least two different attachment locations is on a side of the main body facing a head tube of the frame of the cycle when the main body is mounted on the frame of the cycle.

11. The device of claim 9, wherein at least one attachment location of the at least two different attachment locations is on a lateral side of the main body when the main body is mounted on the frame of the cycle.

12. The device of claim 1, wherein the main body further comprises an additional support member configured to support at least one of a stem or a handlebar of the cycle while the main body is mounted on the frame of the cycle and during servicing of the steering system.

13. A method of servicing a steering system of a cycle, the method comprising:
mounting a device to a frame of the cycle, wherein the device comprises:
a main body configured to be mounted on a frame of a cycle; and
a fork platform configured to extend from the main body and support a fork of the cycle while the main body is mounted on the frame of the cycle and during servicing of the steering system;
removing a stem of the cycle from a steerer tube of a fork of the cycle; and
resting the fork on the fork platform of the device.

14. The method of claim 13, wherein the main body of the device has a surface defining a channel extending in and along the main body, and mounting the device to the frame comprises resting the main body on a tube of the frame of the cycle such that the tube is disposed at least partially within the channel.

15. The method of claim 13, wherein mounting the device to the frame further comprises fastening the main body to the frame using a fastening element.

16. The method of claim 15, wherein the fastening element comprises a strap, and fastening the main body to the frame comprises strapping the main body to the frame.

17. The method of claim 13, wherein the device has at least one compartment within the main body, and wherein servicing the steering system comprises temporarily storing at least one component of the steering system within the at least one compartment during the servicing of the steering system.

18. The method of claim 13, wherein the fork platform and the main body are separable elements, the fork platform being attachable to and detachable from the main body at two or more different attachment locations on the main body, the method further comprising:
supporting the fork on the fork platform while the fork platform is attached to the main body at a first attachment location;
detaching the fork platform from the main body and reattaching the fork platform to the main body at a second attachment location; and
supporting the fork on the fork platform while the fork platform is attached to the main body at the second attachment location.

19. The method of claim 18, wherein a steerer tube of the fork extends through a head tube of the frame while the fork is supported on the fork platform and the fork platform is attached to the main body at the first attachment location.

20. The method of claim 19, wherein the steerer tube of the fork does not extend through the head tube of the frame while the fork is supported on the fork platform and the fork platform is attached to the main body at the second attachment location.

21. The method of claim 19, wherein the steerer tube of the fork extends through the head tube of the frame while the fork is supported on the fork platform and the fork platform is attached to the main body at the second attachment location.

22. The method of claim 13, wherein the main body further comprises an additional support member configured to support at least one of a stem or a handlebar of the cycle, and the method further comprises detaching at least one of the stem or the handlebar from the steerer tube of the fork and supporting the at least one of the stem or the handlebar on the additional support member while servicing the steering system.
